(19) United States
(12) Patent Application Publication
(10) Pub. No.: US 2016/0175631 A1
(43) Pub. Date: Jun. 23, 2016

(54) SYSTEMS AND METHODS FOR CONTROLLED PROJECTION OF FLUID FLOWS

(71) Applicant: Elwha LLC, Bellevue, WA (US)

(72) Inventors: Alistair K. Chan, Bainbridge Island, WA (US); Roderick A. Hyde, Redmond, WA (US); Muriel Y. Ishikawa, Livermore, CA (US); Lowell L. Wood, JR., Bellevue, WA (US)

(73) Assignee: Elwha LLC, Bellevue, WA (US)

(21) Appl. No.: 14/573,082

(22) Filed: Dec. 17, 2014

(51) Int. Cl. B05B 15/08

(52) U.S. Cl. CPC A62C 35/68; A01G 25/00

(57) ABSTRACT

A fluid delivery system includes a pump configured to pump the fluid from a source. The fluid is pumped through a flexible tube extending from the pump and configured to transport the fluid. The fluid delivery system includes at least one ejection site located at a position along the length of the tube, wherein the ejection site is configured to support the fluid delivery system using energy from the fluid pumped through the tube and/or energy from a propulsion fluid.

### BACKGROUND

Fluids may be delivered in a variety of ways, including through the use of generally stationary fluid delivery systems (e.g., pipelines, etc.) and through the use of movable fluid delivery systems (e.g., fire hoses, etc.). Fluid delivery systems are typically supported either by being fixed to another structure, or alternatively, by being controlled by a user of the fluid delivery system.

### SUMMARY

One embodiment relates to a fluid delivery system including a pump configured to pump a fluid from a source. The fluid is pumped through a flexible tube extending from the pump and configured to transport the fluid. The fluid delivery system includes at least one ejection site located at a position along the length of the tube, wherein the ejection site is configured to support the fluid delivery system using energy from the fluid pumped through the tube.

Another embodiment relates to a fluid delivery system including a pump configured to pump the fluid from a source. The fluid is pumped through a flexible tube extending from the pump and configured to transport the fluid. The fluid delivery system further includes at least one ejection module located at an ejection site located at a position along the length of the tube. The ejection module includes a valve configured to control the flow of a pumped liquid, a control circuit configured to control the valve, and a hydraulic turbofan coupled to the valve and configured to use the pumped liquid to generate a force. The hydraulic turbofan is controlled by the control circuit, and wherein the force generated by the hydraulic turbofan at least one of supports the fluid delivery system stabilizes the fluid delivery system, or moves the fluid delivery system.

Another embodiment relates to a fluid delivery system including a pump configured to pump the fluid from a source. The fluid is pumped through a flexible tube extending from the pump and configured to transport the fluid. The fluid delivery system further includes at least one ejection module located at an ejection site located at a position along the length of the tube. The ejection module includes a valve configured to control the flow of a pumped liquid, a control circuit configured to control the valve, and a wing system coupled to the valve and configured to use the pumped liquid to generate a force. The wing system is controlled by the control circuit, and wherein the force generated by the wing system at least one of supports the fluid delivery system stabilizes the fluid delivery system, or moves the fluid delivery system.

Another embodiment relates to a fluid delivery system including a pump configured to pump the fluid from a source. The fluid is pumped through a flexible tube extending from the pump and configured to transport the fluid. The fluid delivery system further includes at least one ejection module located at an ejection site located at a position along the length of the tube. The ejection module includes a valve configured to control the flow of a pumped liquid, a control circuit configured to control the valve, and a support member coupled to the valve and configured to use the pumped liquid to support the fluid delivery system.

Another embodiment relates to a method for delivering a fluid using a fluid delivery system. The method includes pumping the fluid from a source, containing the fluid within a tube of the fluid delivery system, and supporting the fluid delivery system, at least at one ejection site located along the length of the tube, using energy from a pumped liquid.

Another embodiment relates to a method for delivering a fluid using a fluid delivery system. The method includes pumping the fluid from a source, containing the fluid within a tube of the fluid delivery system, and supporting the fluid delivery system, at least at one ejection site located along the length of the tube, using energy from a pumped liquid and a hydraulic turbofan coupled to a valve connected to the tube.

Another embodiment relates to a method for delivering a fluid using a fluid delivery system. The method includes pumping the fluid from a source, containing the fluid within a tube of the fluid delivery system, and supporting the fluid delivery system, at least at one ejection site located along the length of the tube, using energy from a pumped liquid and a wing system coupled to a valve connected to the tube.

Another embodiment relates to a method for delivering a fluid using a fluid delivery system. The method includes pumping the fluid from a source, containing the fluid within a tube of the fluid delivery system, and supporting the fluid delivery system, at least at one ejection site located along the length of the tube, using energy from a pumped liquid and a support member

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A illustrates a fluid delivery system according to one embodiment.

FIG. 1B illustrates a fluid delivery system supported at two ends according to one embodiment.

FIG. 1C illustrates a fluid delivery system supported at an intermediate location according to one embodiment.

FIG. 2A illustrates a valve and nozzle of an ejection module for providing supportive and/or motive force to a fluid delivery system at an ejection site according to one embodiment.

FIG. 2B illustrates a nozzle without an ejection module for providing supportive and/or motive force to a fluid delivery system according to one embodiment.

FIG. 2C illustrates a profile view of an ejection module having a plurality of nozzles according to one embodiment.

FIG. 2D illustrates a nozzle of an ejection module which is controllable using one or more actuators according to one embodiment.

FIG. 2E illustrates a nozzle of an ejection module having controllable vanes which direct ejected fluid according to one embodiment.

FIG. 2F illustrates a valve of an ejection module according to one embodiment.

FIG. 2G illustrates an ejection module including an ejection site pump according to one embodiment.

FIG. 3A illustrates a hydraulic turbofan for providing supportive and/or motive force to a fluid delivery system according to one embodiment.

FIG. 3B illustrates a hydraulic turbofan included in an ejection module according to one embodiment.

FIG. 3C illustrates a wing system for providing supportive and/or motive force to a fluid delivery system according to one embodiment.

FIG. 3D illustrates a wing system included in an ejection module according to one embodiment.

FIG. 3E illustrates a cross section of an annular tube of a fluid delivery system according to one embodiment.

FIG. 3F illustrates a support member which may support a fluid delivery system when pressurized according to one embodiment.

FIG. 3G illustrates a cross section of an annular tube of a fluid delivery system having a plurality of segments according to one embodiment.

FIG. 4 illustrates a block diagram of the electronic components of a fluid delivery system according to one embodiment.

FIG. 5 illustrates a flow chart for a method of delivering fluid using a fluid delivery system according to one embodiment.

FIG. 6A illustrates a fluid delivery system used in a firefighting application according to one embodiment.

FIG. 6B illustrates a fluid delivery system used in an agricultural application according to one embodiment.

FIG. 6C illustrates a fluid delivery system used in an unconventional fluid delivery application according to one embodiment.

### DETAILED DESCRIPTION

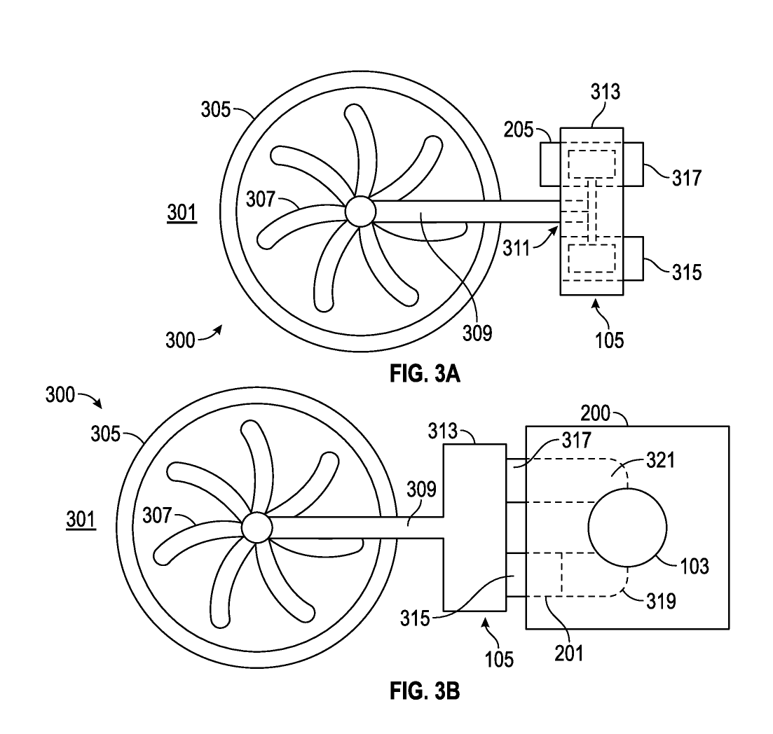

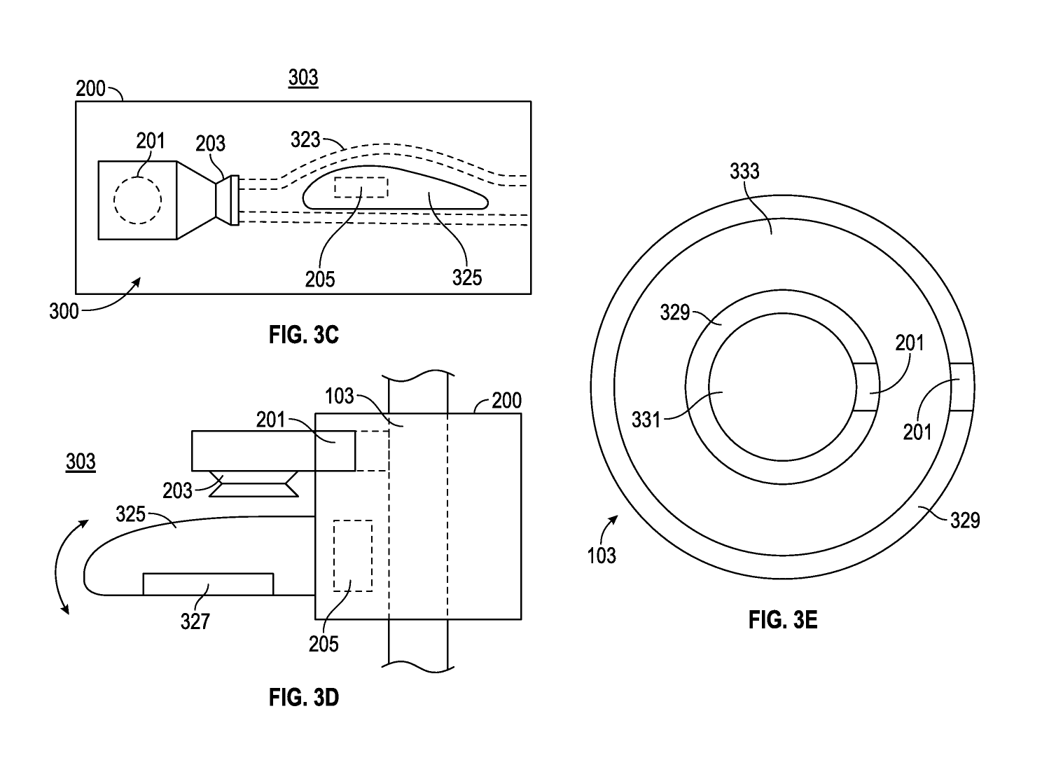

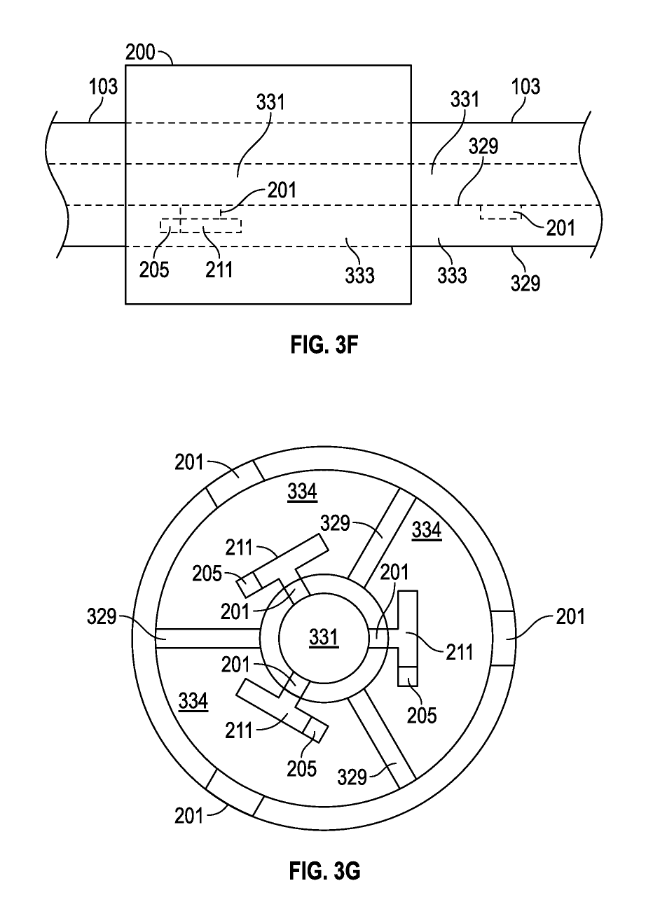

Referring to the figures generally, fluid delivery system 100 is illustrated according to various embodiments. Fluid delivery system 100 uses the energy contained within a fluid such as propulsion fluid 101 in order to support, partially or entirely, fluid delivery system 100. In some embodiments, all components of fluid delivery system 100 are supported, while in other embodiments only portions of fluid delivery system 100 (e.g., tube 103, fluids enclosed within tube 103, or both) are supported. As explained in greater detail with reference to FIGS. 3E-3F, propulsion fluid 101 may be the same fluid delivered by fluid delivery system 100, or may be a separate fluid used in supporting fluid delivery system 100. The fluid delivered by fluid delivery system 100 may be delivered from a source to an outlet port of fluid delivery system 100. The fluid delivered by fluid delivery system 100 may comprise a liquid, a gas, an aerosol, or a slurry. Propulsion fluid 101 may comprise a liquid, a gas, an aerosol, or a slurry. Advantageously, fluid delivery system 100 may include one or more sections of tube 103 which are self-supported by propulsion fluid 101. This allows tube 103 to deliver one or more fluids over great distances without additional support structures or devices separate from fluid delivery system 100. Fluid delivery system 100 provides a further advantage in that energy used to pump propulsion fluid 101 may be partially recaptured to provide support for fluid delivery system 100.

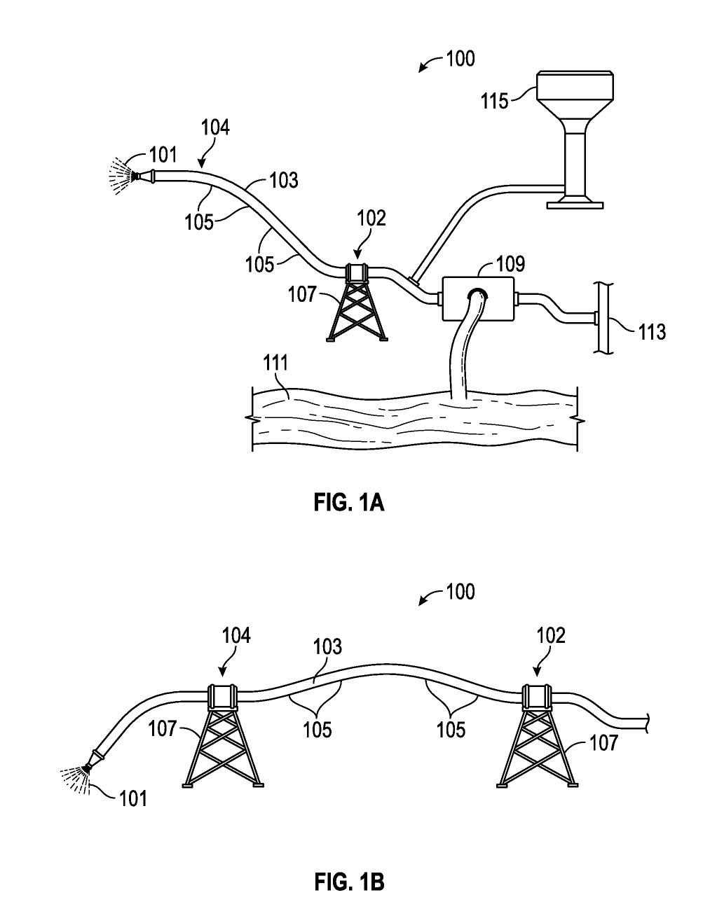

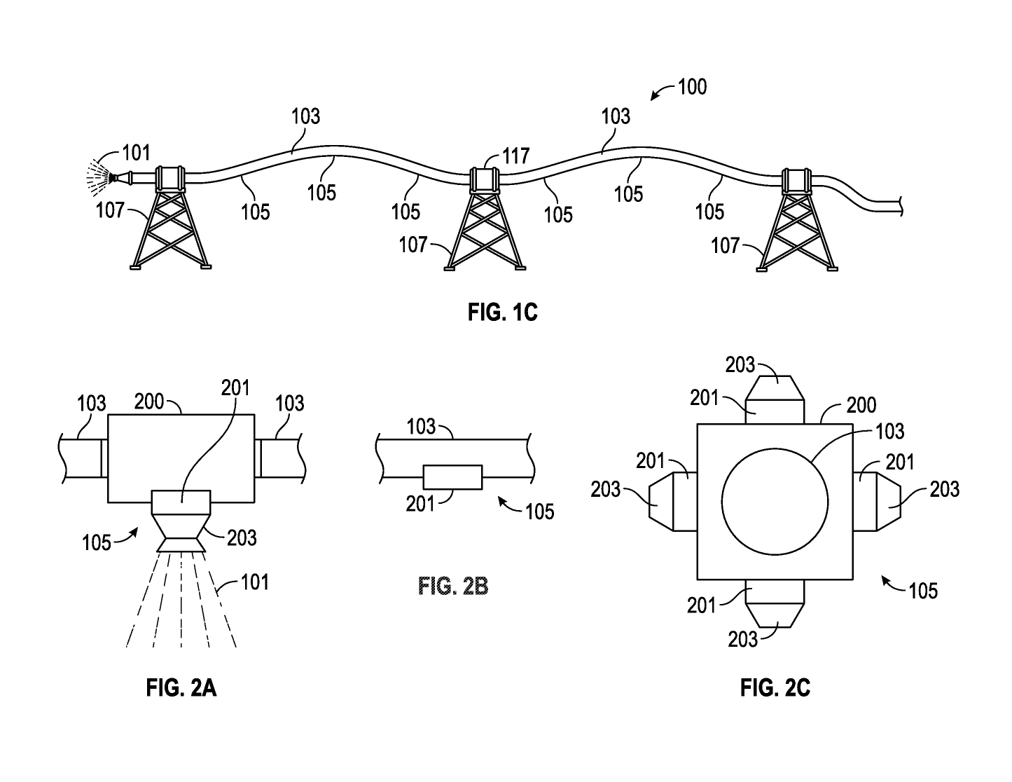

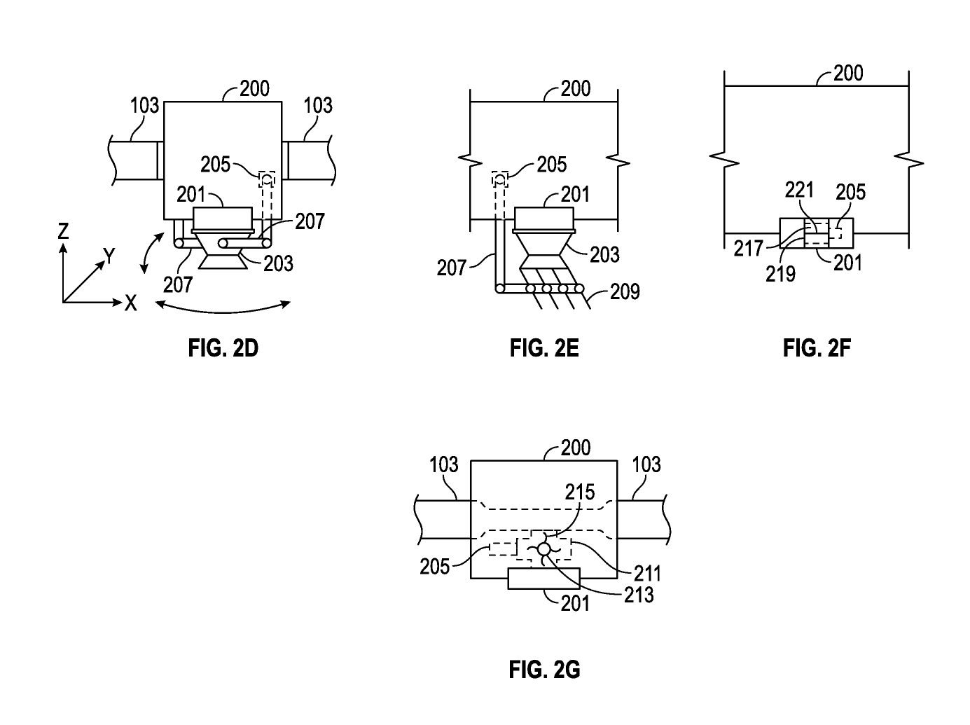

Referring now to FIG. 1, fluid delivery system 100 is illustrated according to one embodiment. Fluid delivery system 100 includes tube 103 (e.g., a flexible tube, a rigid tube, etc.) through which a fluid is delivered. The fluid may be propulsion fluid 101 which is also used to support one or more portions of fluid delivery system 100. In alternative embodiments, the fluid delivered by fluid delivery system 100 is separate from propulsion fluid 101, with propulsion fluid 101 being used to support fluid delivery system 100. Tube 103 of fluid delivery system 100 is supported at one or more ejection sites 105. Tube 103 is supported at ejection site 105 by propulsion fluid 101. As explained in greater detail with reference to FIGS. 2A-3D, tube 103 is supported at ejection site 105 by the discharge of propulsion fluid 101.

In some embodiments, propulsion fluid 101 may be pumped by pump 109. Pump 109 may be any pump suitable for pumping or otherwise raising the pressure of a fluid such as propulsion fluid 101 (e.g., water, oil, fuel, air or other fluids). Pump 109 may be one or more of a plurality of pump types such as positive displacement pumps, impulse pumps, velocity pumps, gravity pumps, multiphase pumps, or other types of pumps. In some embodiments, pump 109 may be a centrifugal pump, injector pump, reciprocating piston pump, screw pump, rotary lobe pump, or other pump. In some embodiments, pump 109 may be supported by ejection site 105, while in other embodiments pump 109 is supported by the ground or another fixed or mobile support structure.

In some embodiments, pump 109 includes a plurality of pumps 109. One set of pumps 109 (e.g., a set having a single pump 109 or multiple pumps 109) may be used to pump a fluid through tube 103 which is delivered by fluid delivery system 100. This fluid delivered by fluid delivery system 100 is not used to support fluid delivery system in some embodiments. A second set of pumps 109 (e.g., a set having a single pump 109 or multiple pumps 109) may be used to pump propulsion fluid 101. Propulsion fluid 101 may be used at ejection sites 105 to support fluid delivery system 100 in whole or in part.

Pump 109 may draw propulsion fluid 101 from a variety of sources. In some embodiments, pump 109 draws propulsion fluid 101 from main 113. Main 113 may be any type of piping system or fluid delivery system containing propulsion fluid 101 prior to being pumped by pump 109. Main 113 may contain propulsion fluid 101 under pressure. For example, main 113 may be used to pump propulsion fluid 101 from one location to another. Pump 109 may draw propulsion fluid 101 from main 113. Advantageously, this may reduce the amount of work done by pump 109 in pumping propulsion fluid 101 as propulsion fluid 101 is already under pressure in main 113.

In some embodiments, pump 109 draws propulsion fluid from open source 111. Open source 111 may be a naturally occurring or manmade source such as a river, lake, pond, reservoir, open storage pool, vat, closed storage container, or other source. In further embodiments, propulsion fluid 101 may be delivered to pump 109 or bypass pump 109 from gravity fed source 115. Advantageously, gravity fed source 115 may contain propulsion fluid 101 at a pressure which allows for use of propulsion fluid 101 without pump 109. In such a case, fluid delivery system 100 might not include pump 109. Gravity fed source 115 may be any source of propulsion fluid 101 which provides propulsion fluid 101 to fluid delivery system 100 under pressure due to gravity flow of propulsion fluid 101. For example, gravity fed source 115 may be a water tower, reservoir at a higher altitude than fluid delivery system 100, or other source.

In some embodiments, fluid delivery system 100 is further supplied an additional fluid to deliver from one or more of main 113, open source 111, gravity fed source 115, and/or another source. The additional fluid may be delivered by fluid delivery system 100 while fluid delivery system 100 is supported by propulsion fluid 101.

In some embodiments, fluid delivery system 100 is supported at first end 102 by support structure 107. Support structure 107 may secure and/or support fluid delivery system 100. Support structure 107 may be any structure used to support a portion of fluid delivery system 100. For example, support structure 107 may be a scaffolding type structure which secures a portion of tube 103 with a clamp or other securing hardware. In some embodiments, support structure 107 may be a mobile support mechanism. For example, support structure may be mounted on wheels, tracks, a crane, a ladder, a fire truck, or otherwise allow for the movement of support structure 107. Advantageously, this allows for the repositioning and/or movement of fluid delivery system 100. In alternative embodiments, support structure 107 is fixed.

Fluid delivery system 100 is supported at second end 104 by one or more ejection sites 105. In some embodiments, fluid delivery system is supported in intermediate locations by an additional one or more ejection sites 105. Ejection sites 105 support 50% of the mass of fluid delivery system 100 in some embodiments. In alternative embodiments, ejection sites 105 support between 50% to 100% of the mass of fluid delivery system 100. In further alternative embodiments, ejection sites 105 support less than 50% of the mass of fluid delivery system 100.

Referring now to FIG. 1B, fluid delivery system 100 is supported at first end 102 and second end 104 by support structures 107 in some embodiments. Fluid delivery system 100 may be supported between support structures 107 by one or more ejection sites 105. Advantageously, the use of a plurality of support structures 107 may allow fluid delivery system 100 to deliver fluid a greater distance. In some embodiments, support structures 107 are fixed. In other embodiments, one or more support structures 107 are mobile. For example, one support structure 107 may be fixed while a second support structure 107 is mobile. The first support structure 107 may allow fluid delivery system 100 to pivot about the first support structure 107. Advantageously, this may allow fluid delivery system 100 to deliver fluid to a variety of locations on an arc centered on the first support structure 107.

Referring now to FIG. 1C, fluid delivery system 100 is supported at one or more ends and at one or more intermediate locations by support structures 107 in some embodiments. Intermediate support structures 107 may provide additional support to fluid delivery system 100. Between support structures 107, fluid delivery system 100 is supported by one or more ejection sites 105. In some embodiments, fluid delivery system 100 may include a plurality of tube 103 sections. Tubes 103 may be joined by connection hardware 117 (e.g., tubes, fittings, clamps, conduits, and/or other hardware). Connection hardware 117 may also provide an attachment point for support structure 107.

Referring now to FIG. 2A, ejection site 105 and associated hardware is illustrated according to one embodiment. In some embodiments, ejection site 105 includes valve 201 used to control the flow of propulsion fluid 101. Nozzle 203 may be used to direct or otherwise alter the flow of propulsion fluid 101 from ejection site 105. Propulsion fluid 101 ejected from ejection site 105 may provide lift which supports a portion of tube 103 and/or other portion of fluid delivery system 100. The reaction forces from the ejection of propulsion fluid 101 provide lift and/or other forces to move and/or support tube 103 and/or fluid delivery system 100.

In some embodiments, valve 201, nozzle 203, and/or supporting hardware and/or electronics are housed within ejection module 200. First tube 103 and second tube 103 may attach to ejection module 201. Fluid delivery system 100 may include a plurality of ejection modules 200. Ejection module 200 may be provided at each ejection site 105. Ejection modules 200 may have different configurations. In alternative embodiments, valve 201, nozzle 203 and/or other supporting hardware and/or electronics are included within tube 103 (e.g., are integrated with tube 103 rather being housed within ejection module 200.

Valve 201 controls the flow of propulsion fluid 101 exiting fluid delivery system 100 at ejection site 105. In some embodiments, valve 201 controls fluid flow between an on and off state. In alternative embodiments, valve 201 controls the flow rate of propulsion fluid 101 exiting fluid delivery system 100, such that valve 201 may have a variety of positions between fully open and fully closed which determine the flow rate of propulsion fluid 101. Valve 201 may be any type of valve. For example, valve 201 may be one or more of a butterfly valve, ball valve, globe valve, disc valve, or other type of valve. In some embodiments, valve 201 is controlled by an actuator. For example, valve 201 may include or otherwise be controlled by a solenoid. Valve 201 may be a solenoid valve. In further embodiments, the actuator may be an actuator capable of positioning valve 201. For example, the actuator may be a stepper motor or other electrically controlled actuator.

Nozzle 203 may be used to direct or otherwise alter the flow of propulsion fluid 101 from ejection site 105. In further embodiments, nozzles 203 control the rate of flow, speed, total mass, shape, or other characteristics of propulsion fluid 101 exiting fluid delivery system 100 at ejection site 105. Nozzles 203 may be a jet type, high velocity type, propelling type, spray type, shaping type, or other type.

Referring now to FIG. 2B, tube 103 at ejection site 105 is illustrated according to one embodiment. Tube 103 may include an integral valve 201 which controls the flow of propulsion fluid 101 from tube 103 at ejection site 105. Flow from valve 201 may provide lift or other force for supporting and/or moving tube 103 of fluid delivery system 100 using the reaction forces resulting from the discharge of propulsion fluid 101. Valve 201 may be coupled to nozzle 203 in some embodiments.

Referring now to FIG. 2C, fluid delivery system 100 is illustrated with an end view at ejection site 105 according to one embodiment. In some embodiments, fluid delivery system includes a plurality of valves 201 at each ejection site 105. The plurality of valves 201 may be used to provide support, lift, torque, and/or motive force in a plurality of directions at ejection site 105. Control of valves 201 may be used to control the support and/or movement of fluid delivery system 100 using the reaction forces resulting from the ejection of propulsion fluid 101 from one more of the plurality of valves 201. In some embodiments, valves 201 and/or other related hardware and/or electronics are housed partially or completely in ejection module 200. In alternative embodiments, valves 201 and/or other related hardware and/or electronics are integrated partially or completely into tube 103. In some embodiments, valves 201 are coupled to nozzles 203. Nozzles 203 may further direct the flow of ejected propulsion fluid 101. Nozzles 203 may be used to steer, twist, or otherwise move fluid delivery system 100 in a desired direction or orientation through direction of ejected propulsion fluid 101 in some embodiments. Valves 201 may also control the flow rate or other characteristics of propulsion fluid 101 exiting fluid delivery system 100.

In some embodiments, four valves 201 and/or nozzles 203 are included in fluid delivery system 100 at one or more ejection sites 105. Four valves 201 and/or nozzles 203 may provide support and or motive force at ejection site 105 corresponding to lift and lateral movement. Advantageously, providing four valves 201 and/or nozzles 203 allows for lift force to be generated independent of the twist or other orientation of tube 103 and/or fluid delivery system 100. In other words, at least one valve 201 and/or nozzle 203 will be directed at least partially in the direction of lift regardless of the orientation of tube 103 and/or other components of fluid delivery system 100. In some embodiments, two or more valves 201 or nozzles 203 may be used to apply torque at ejection site 105, so as to control the orientation or angular direction of tube 103 or other components at ejection site 105. This control may insure that another valve 201 or nozzle 203 is oriented correctly to apply force in a desired direction, or to insure that an outlet port for another fluid (e.g., water delivered for fire suppression) is oriented properly.

In alternative embodiments, more or fewer valves 201 and/or nozzles 203 are included in fluid delivery system 100 at each ejection site 105. For example, additional valves 201 and/or nozzles 203 may be included to control advancing and/or retreating motion of tube 103 and/or fluid delivery system 100. In further alternative embodiments, nozzles 203 are used to direct the flow of propulsion fluid 101 to provide for advancing and/or retreating motion of tube 103 and/or other components of fluid delivery system 100. Nozzles 203 may further be used to control lateral and/or lifting motion or support of fluid delivery system 100.

Referring now to FIG. 2D, fluid delivery system 100 is illustrated at ejection site 105 having a steerable or otherwise controllable nozzle 203 in some embodiments. In some embodiments, the direction of fluid flow from nozzle 203 is controlled using one or more actuators 205 coupled to nozzle 203. Actuator(s) 205 may be any source of mechanical motion such as a solenoid, stepper motor, or other electromechanical actuator. In some embodiments, actuator(s) 205 control the direction of nozzle 203 using mechanical linkage 207. In some embodiments, nozzle 203 is controlled in a single direction (e.g., along the x-axis of motion). In alternative embodiments, nozzle 203 is controlled in multiple directions (e.g., along the x-axis of motion and along the y-axis of motion).

Referring now to FIG. 2E, in alternative embodiments, nozzle 203 include vanes 209 used to control the direction of ejected propulsion fluid 101. Vanes 209 may be controlled by one or more actuators 205 to control the direction of propulsion fluid 101 exiting nozzle 203. Actuator(s) 205 may be coupled to vanes 209 via linkage 207. Vanes 209 may be located externally to nozzle 203. In alternative embodiments, vanes 209 are located within or partially within nozzle 203.

Referring now to FIG. 2F, valve 201 is illustrated according to one embodiment. Valve 201 may include actuator 205 as an integrated component. For example, valve 201 may be a solenoid valve and actuator 205 may be a solenoid. In alternative embodiments, actuator 205 may be located remote from valve 201 and control valve 201 via mechanical linkage 207.

In some embodiments, valve 201 is a butterfly valve driven by actuator 205. Actuator 205 may be a stepper motor or other actuator capable of actuating valve 201 by degree. Actuator 205 may rotate shaft 221 of valve 201. Coupled to shaft 221 are upper plate 217 and lower plate 219. Upper plate 217 and lower plate 219 may be rotated by degree between a closed and open position. Actuator 205 may therefore control the flow through valve 201 and the amount of propulsion fluid 101 which is ejected at ejection site 105. Therefore, lift and/or motive force from propulsion fluid 101 exiting fluid delivery system 100 may be regulated. In further alternative embodiments, valve 201 is one or more other types of valves.

Referring now to FIG. 2G, ejection site pump 211 is included at one or more ejection sites 105 of fluid deliver system 100 in some embodiments. Ejection site pump 211 may be used to provide increased pressure, flow rate or speed of propulsion fluid 101 as propulsion fluid 101 is used to provide lift or motive force when ejected at ejection site 105. Ejection site pump 211 provides for greater lift and/or motive force through the ejection of propulsion fluid 101 at a higher pressure than if propulsion fluid 101 was ejected directly from tube 103 or ejection site module 200. Ejection site pump 201 is situated between tube 103 and valve 201 in some embodiments. In alternative embodiments, ejection site pump 211 may be in line with tube 103 or otherwise boost propulsion fluid 101 traveling within fluid delivery system 100.

In some embodiments, ejection site pump 211 is a centrifugal pump. Hub 213 may be powered or otherwise driven by actuator 205. Vanes 215 coupled to hub 213 are driven by hub 213 and provide mechanical pumping. In alternative embodiments, ejection site pump 211 is a different type of pump. For example, ejection site pump 211 may be a gear pump, scroll pup, screw pump, or other type of pump. Pump 211 may be a positive displacement pump, impulse pump, velocity pump, or other class of pump.

Ejection site pump 211 is powered by actuator 205. Actuator 205 may be any source of mechanical power such as an electric motor, hydraulic motor, engine, or other source of mechanical power. In one embodiment, actuator 205 is an electric motor which drives ejection site pump 211. Actuator 205 may be powered by any electrical source. For example, actuator 205 may be powered by a wired connection to a power supply such as a battery, generator, or mains power. The wired connection may run the length of fluid delivery system 100 to a power source located at one end of fluid delivery system 100. Advantageously, fluid delivery system 100 does not support the weight of a power source but instead only supports the weight of the wire which delivers power to actuators 205. In alternative embodiments, actuator 205 may be powered by a local rechargeable battery (e.g., a battery included in ejection site module 200).

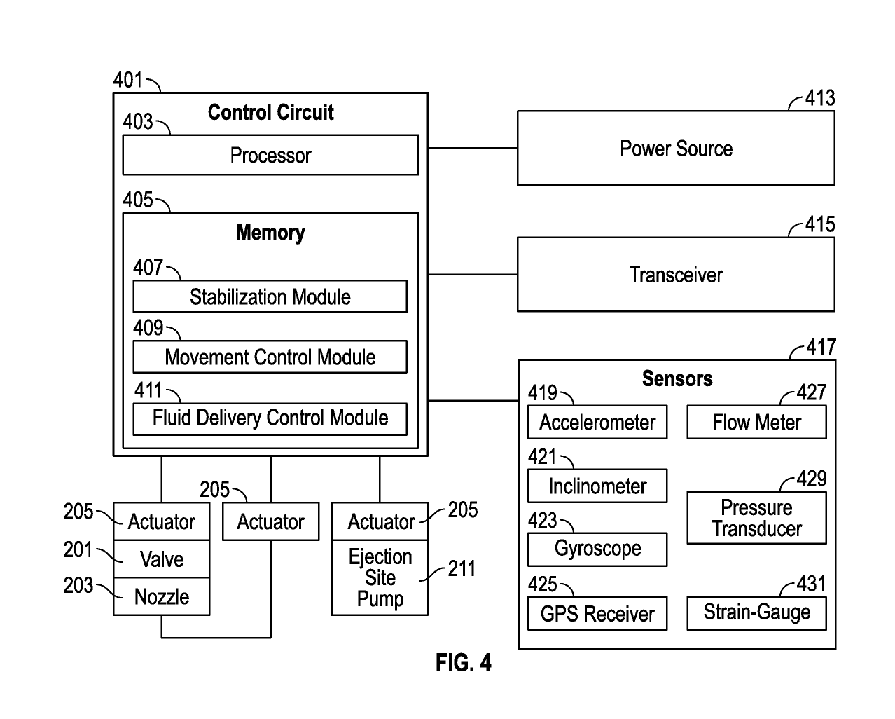

Referring generally to FIGS. 2A-2G, lift and/or motion of fluid delivery system 100 at ejection site 105 is controlled by a combination of valve(s) 201 and/or nozzle(s) 203. Using valve(s) 201, nozzle(s) 203, and/or other components (e.g., actuator(s) 205), the movement, orientation, and/or location of fluid delivery system 100 is controlled. For example, fluid delivery system 100 may be supported against gravitational forces by the ejection of propulsion fluid 101. In order to prevent fluid delivery system 100 from achieving excess lift, valve 201, nozzle 203, and/or ejection site pump 211 may be controlled to regulate the amount of lifting force generated by the ejection of propulsion fluid 101. For example, valve 201 may be partially opened or closed to regulate the flow rate of propulsion fluid 101 being ejected, nozzle 203 may be directed such that a portion of the ejected propulsion fluid 101 provides lift force and a second portion provides lateral motive force, ejection site pump 211 may be controlled to alter the flow rate, pressure, and/or other parameters of the ejected propulsion fluid 101, thereby supporting fluid delivery system 100 without achieving movement (e.g., maintain the location of fluid delivery system 100), and/or other techniques maybe used. One or more control systems may control valve(s) 201, nozzle(s) 203, actuator(s) 205, ejection site pump(s) 211, and/or other components in order to achieve positioning, support, and/or movement of fluid delivery system 100 as described with greater detail in reference to FIG. 4.

Referring now to FIGS. 3A-3G, a variety of support devices 300 are illustrated according to various embodiments. Support devices 300 are used to provide support and/or motive force for fluid delivery system 100. Support devices 300 may increase the specific impulse available from momentum of propulsion fluid 101 and/or other fluids delivered by fluid delivery system 100. Support devices 300 may be or function as force enhancers. This may provide for greater support, supporting force, and/or motive force in comparison to ejecting propulsion fluid 101 or another fluid at ejection sites 105 alone and/or through nozzle 203. Support devices 300 may act as force enhancers at ejection sties 105. Support devices 300 may further behave like rigid or semi rigid support members (e.g., support segments). Support devices 300 may transfer force and/or stress on fluid delivery system 100 (e.g., due to the weight of fluid delivery system 100) to ejection sites 105 (e.g., ejection site modules 200) and/or support structures 107.

Referring now to FIG. 3A, a support device shown as hydraulic turbofan 301 is illustrated according to one embodiment. Hydraulic turbofan 301 is powered by propulsion fluid 101 or other fluid of fluid delivery system 100. Hydraulic turbofan 301 provides supportive force and/or motive force by displacing air using blades 307. Blades 307 may be contained within shroud 305. Blades 307 are driven by shaft 309. Shaft 309 is driven by hydraulic drive system 311. Hydraulic drive system 311 is contained within housing 313. Propulsion fluid 101 or another fluid contained within fluid delivery system 100 enters housing 313 through inlet 315. The fluid or propulsion fluid 101 provides motive force to hydraulic drive system 311 and exits housing 313 through outlet 317. In some embodiments, the orientation of hydraulic turbofan 301 is controlled by actuator 205. Actuator 205 may change the orientation of hydraulic turbofan 301 and control the direction of thrust provided by hydraulic turbofan 301.

In some embodiments, hydraulic turbofan 301 includes shroud 305. Shroud 305 partially surrounds blades 307. Shroud 305 may enhance the lift produced by blades 307, direct thrust produced by blades 307, partially prevent objects from coming into contact with blades 307, and/or perform other functions. In some embodiments, shroud 305 prevents objects from coming into contact with blades 307 by acting as a barrier. For example, shroud 305 may include a mesh or wire screen which prevents objects from entering hydraulic turbofan 301. In alternative embodiments, hydraulic turbofan 301 does not include shroud 305.

Blades 307 generate thrust by rotating around a central axis or hub. Blades 307 are shaped to produce thrust. In some embodiments, blades 307 may have a variable and controllable angle of attack. Advantageously, this allows for control of the amount of thrust produced by hydraulic turbofan 301. In alternative embodiments, the angle of attack of blades 307 is fixed. In various embodiments, blades 307 have a variety of configurations including varying number of blades 307, varying angles of attack, varying size, and/or varying other characteristics. Blades 307 are driven by shaft 309.

Shaft 309 is a mechanical linkage between blades 307 and hydraulic drive system 311. Shaft 309 may be contained within a housing extending from housing 313 to blades 307. The housing may protect and/or secure shaft 309. In some embodiments, the housing around shaft 309 is driven by actuator 205 to change the orientation of hydraulic turbofan 301. This allows for control of the thrust produced from hydraulic turbofan 301. Thrust may be directed through actuator 205 and the changing orientation of hydraulic turbofan 301 to provide a force to support fluid delivery system 100, stabilize fluid delivery system 100, and/or move fluid delivery system 100. Shaft 309 may include a hub, gear train, and/or other mechanical components to connect shaft 309 to blades 307, change the direction of mechanical force, provide a mechanical advantage, and/or otherwise deliver power to blades 307. In some embodiments, shroud 305 is coupled to a housing of shaft 309 and/or a hub connecting blades 307 to shaft 309.

Hydraulic drive system 311 provides mechanical power (e.g., rotation) to shaft 309 to power blades 307. Hydraulic drive system 311 may be any mechanical system for converting fluid flow to mechanical motion. For example, hydraulic drive system 311 may include a shaft and a plurality of vanes. The vanes rotated by propulsion fluid 101 and/or another fluid in fluid delivery system 100 in turn cause the shaft to rotate. The shaft is or is coupled to shaft 309. In some embodiments, hydraulic drive system 311 is located within housing 313. Fluid may enter housing 313 from inlet 315 under pressure and drive hydraulic drive system 311 (e.g., rotate one or more vanes and the attached shaft). The fluid may exit housing 313 through outlet 317. Other hydraulic drive systems 311 are used to power shaft 309 in alternative embodiments.

In some embodiments, thrust from hydraulic turbofan 301 is directed by changing the orientation of hydraulic turbofan 301 using actuator 205. Actuator 205 may be any actuator which causes blades 307, shroud 305, and/or shaft 309 to rotate (e.g., relative to housing 313). For example, actuator 205 may be a stepper motor which causes blades 307, shroud 305, and/or shaft 309 to rotate relative to housing 313.

Referring now to FIG. 3B, hydraulic turbofan 301 is coupled to ejection module 200 in some embodiments. One or more hydraulic turbofans 301 may be coupled to ejection modules 200. Inlet 315 of hydraulic turbofan 301 may be coupled to valve 201 within ejection module 200. Valve 201 may be coupled to inlet piping 319, which couples valve 201 and hydraulic turbofan 301 to tube 103. This allows propulsion fluid 101 or another fluid carried by fluid delivery system 100 to enter housing 313 of hydraulic turbofan 301 and serve as a power source. Propulsion fluid 101 and/or another fluid may provide hydraulic power through hydraulic drive system 311.

Outlet 317 of hydraulic turbofan 301 may be coupled to outlet piping 321 which couples housing 313 to tube 301. Outlet piping 321 allows propulsion fluid 101 and/or another fluid used to drive hydraulic turbofan 301 to re-enter tube 103 and to be delivered or otherwise pumped or moved by fluid delivery system 100.

Advantageously, propulsion fluid 101 and/or another fluid of fluid delivery system 100 may be used to power hydraulic turbofan 301 and be recaptured, rather than ejected, using inlet piping 319 and outlet piping 317. This allows for propulsion fluid 101 and/or another fluid to be delivered using fluid delivery system 100 and to power hydraulic turbofan 301 without being expelled or ejected from fluid delivery system 100, increasing the amount of propulsion fluid 101 and/or other fluid delivered.

Valve 201 may be controlled (e.g., by a control circuit system) to determine the amount, pressure, and/or other characteristics of the fluid used to drive hydraulic turbofan 301 (e.g., enter housing 313 and drive hydraulic drive system 311). Valve 201 may control the amount of thrust provided by hydraulic turbofan 301 by controlling the amount of fluid which drives hydraulic drive system 311. Advantageously, valve 201 may be used alone or in conjunction with other components of fluid delivery system 100 to control the forces used to support, stabilize, and/or move fluid delivery system 100. Valve 201 and actuator 205 may be used in conjunction to control the amount of thrust and the direction of thrust produced by hydraulic turbofan 301.

In alternative embodiments, hydraulic turbofan 301 may be connected directly to fluid delivery system 100 without ejection module 200. For example, housing 313 of hydraulic turbofan 301 may be coupled directly to tube 103 of fluid delivery system 100. Valve 201 may be located within housing 313.

Referring now to FIG. 3C, wing system 303 is illustrated according to one embodiment. Wing system 303 may be used to provide lift for supporting, stabilizing, and/or moving fluid delivery system 100. Wing system 303 provides lift ejecting fluid over wing 325. The fluid (e.g., propulsion fluid 101 and/or another fluid of fluid delivery system 100) creates lift when traveling around wing 325. In one embodiment, the fluid is ejected as fine mist 323 (i.e., as an aerosol) which drags air along with it. This air may create lift when traveling over wing 325. In some cases, mist 323 may cause suction which drives air over wing 325. To create mist 323, propulsion fluid 101 and/or another fluid is ejected from fluid delivery system 100 under pressure and through nozzle 203. Nozzle 203 is configured to create mist 323.

In some embodiments, the flow of propulsion fluid 101 and/or another fluid is controlled by valve 201. Valve 201 may control the pressure, flow rate, amount, and/or other characteristics of propulsion fluid 101 and/or another fluid which is ejected through nozzle 203. This in turn controls the amount of lift generated by wing system 303. In some embodiments, actuator 205 controls the angle of attack of wing 325. This controls the amount and/or direction of lift generated by wing system 303.

Referring now to FIG. 3D, an overhead view of wing system 303 is illustrated according to one embodiment. One or more components of wing system 303 may be housed or otherwise located in or on ejection module 200. Ejection module 200 may include one or more wing systems 303. Wing system 303 draws propulsion fluid 101 and/or another fluid from tube 103 of fluid delivery system 100. Nozzle 203 may be configured to eject mist 323 across all or a substantial portion of wing 325.

In some embodiments, wing 325 includes aileron 327. Aileron 327 may be controlled by actuator 205. Aileron 327 may be controlled to change the direction of lift created by wing 325. Using one or more ailerons 327 (e.g., a pair of wings 325 having ailerons 327) the support, stabilization, and/or movement of fluid delivery system 100 may be controlled. For example, a pair of ailerons 327 may be used to roll fluid delivery system 100.

Referring now to FIG. 3E, a cross section of tube 103 of fluid delivery system 100 is illustrated according to one embodiment. Tube 103 may be an annular tube with one or more separate regions. Regions are created by concentric tube walls 329. In one embodiment, tube 103 includes center channel 331 and annulus 333. Center channel 331 may carry a fluid to be delivered by fluid delivery system 100. Annulus 333 may carry propulsion fluid 101 which is used to support, stabilize, and/or move fluid delivery system 100. Advantageously, the fluid to be delivered and propulsion fluid 101 may be different fluids. For example, a petroleum product may be delivered through center channel 331 while water, as propulsion fluid 101, is proved through annulus 333 and ejected along fluid delivery system 100 at ejection sites 105. This allows all of a fluid for delivery to be delivered while a second fluid may be ejected to support fluid delivery system 100. Other fluid combinations may be used.

In alternative embodiments, the fluids in center channel 331 and annulus 333 are the same fluid. One or more annuli may be used to support fluid delivery system 100 as explained in greater detail with reference to FIG. 3F. Tube 103 may include a plurality of concentric channels including center channel 331 and one or more annuli 333. In some embodiments, tube 103 delivers fluids in lumens having a more general configuration than central channel 331 and annulus 333. Tube 103 can contain a plurality of lumens containing delivery fluid and/or propulsion fluid; these lumens may be concentric, or may be side-by-side, may spiral around each other, etc.

Fluid movement between center channel 331 and annulus 333 (or more general lumens) may be controlled by one or more valves 201. Valves 201 control fluid flow through tube walls 329. Valves 201 may also control the flow of fluid from tube 103 to other components such as those previously described as housed within and/or or associated with ejection module 201.

Referring now to FIG. 3F, in some embodiments fluid delivery system 100 includes support segments included within tube 103 which support fluid delivery system 100. Support segments are flexible portions of tube 103 which may be pressurized to create a rigid or semi-rigid structure. This structure may be used to support the weight of fluid delivery system 100. Support segments may also be used to control the shape of tube 103. Rather than dipping between ejection sites 105, tube 103 may be substantially straight due to pressurized support segments between ejection sites 105 which result in a rigid or semi rigid structure supported at ejection sites 105.

In some embodiments, support segments are formed by a lumen or annulus 333 of tube 103. Fluid is delivered through center channel 331 or a different annulus 333. Tube walls 329 are typically flexible in some embodiments, but pressurization of one or more annuli 333 may create a rigid or semi rigid structure. Fluid (e.g., propulsion fluid 101 and/or another fluid) may be allowed to enter annulus 333 from a different annulus 333 or center channel 331. The fluid enters through valve 201 which may be controlled by actuator 205. The fluid may then be pressurized within annulus 333 by ejection site pump 211. Ejection site pump 211 may be powered by actuator 205. Pressure may be increased until annulus 333 is rigid or semi-rigid with the pressure contained by tube walls 329. Tube walls 329 may substantially prevent contraction of the cross section area of center channel 331 and/or another annulus 333. This allows for substantially unrestricted flow through center channel 331 and/or other annuli 333. The pressurized annulus 333 makes tube 103 rigid or semi-rigid which allows for tube 103 to transfer loads between ejection sites 105 and/or support structures 107.

Annulus 333 may be depressurized using one or more valves 201. In some embodiments, valve(s) 201 allow fluid from pressurized annulus 333 to re-enter center channel 331 and/or other annuli 333 from which the fluid was drawn to pressurize annulus 333. Advantageously, this allows for the use of fluid to support fluid delivery system 100 via support segments and for the recapture of the fluid for delivery.

In some embodiments, support segments extend from one ejection site 105 to another ejection site 105. Annulus 333 is capped or divided at each ejection site 105. This allows for greater control of the shape and/or support of fluid delivery system 100. Valve 201, actuator 205, and/or ejection site pump 211 may be included in ejection site module 200. In alternative embodiments, support segments are segmented at different intervals. For example, several support segments may be located between each ejection site 105. Valves 201, actuators 205, pumps 211, and/or other components may be located within annulus 333 and outside of ejection site module 200.

Referring now to FIG. 3G, in some embodiments annulus 333 may be segmented into two or more segments 334. This may allow for greater control over the shape and/or support of fluid delivery system 100. Different segments 334 of annulus 333 may be pressurized to different pressures allowing for different rigidities. This may allow tube 103 to be shaped into a desired shape or steered in a desired direction. Segments 334 may be separated by tube walls 329. Each segment may include pump 211, actuator 205, valve 201, and/or other components. This allows each segment 334 of annulus 333 to be independently pressurized.

Referring generally to FIGS. 3A-3G, support devices 300 are controlled by a control system in some embodiments. Actuators 205, valves 201, and/or other components of support devices 300 may be controlled by a control system as described with greater detail in reference to FIG. 4. The control system may control the orientation, status, and/or operation of support devices 300 directly or through intermediate components (e.g., actuators 205). The control system may control support devices 300 in order to provide support and/or motive force to fluid delivery system 100. Support devices 300 may be controlled to control the position and/or movement of fluid delivery system 100. Support devices of various varieties described with reference to FIGS. 3A-3G may be used in conjunction.

Referring now to FIG. 4, various components of fluid delivery system 100 are illustrated according to one embodiment. In one embodiment, components of fluid delivery system 100 are located in one or more ejection modules 200. In alternative embodiments, components may be located elsewhere through fluid delivery system 100 and/or remotely.

Fluid delivery system 100 includes control circuit 401. Control circuit 401 controls components of fluid delivery system 100. For example, control circuit 401 controls actuators 205, valves 201, and/or other components. Control circuit 401 may control these and/or other components to carry out the functions of fluid delivery system 100 described herein. For example, control circuit 401 may control actuators 205 and valves 201 to provide support, stabilization, and/or movement of fluid delivery system 100 (e.g., using support devices 300) as desired (e.g., according to user input and/or control software). Control circuit 401 may further perform functions such as determining the position, orientation, velocity, and/or other information pertaining to one or more portions of fluid delivery system 100. These functions may be performed using information received from transceiver 415 and/or sensors 417. Control circuit 401 may determine the forces to support, stabilize, and/or move fluid delivery system 100 based on information determined about fluid delivery system 100. Control circuit 401 may control components of fluid delivery system 100 to generate the forces or torques (e.g., support devices 300, ejections sites 105, ejection modules 200, etc.).

Control circuit 401 may contain circuitry, hardware, and/or software for facilitating and/or performing the functions of fluid delivery system 100 described herein. Control circuit 401 may handle inputs, process inputs, run programs, handle instructions, route information, control memory, control a processor, process data, generate outputs, communicate with other devices or hardware, and/or otherwise perform general or specific computing tasks.

Control circuit 401 may further include processor 403, and/or memory 405. Processor 403 may be implemented as a general-purpose processor, an application specific integrated circuit (ASIC), one or more field programmable gate arrays (FPGAs), a digital-signal-processor (DSP), a group of processing components, or other suitable electronic processing components. Memory 405 is one or more devices (e.g., RAM, ROM, Flash Memory, hard disk storage, etc.) for storing data and/or computer code for facilitating the various processes described herein. Memory 405 may be or include non-transient volatile memory or non-volatile memory. Memory 405 may include database components, object code components, script components, or any other type of information structure for supporting the various activities and information structures described herein. Memory 405 may be communicably connected to processor 403 and provide computer code or instructions to processor 403 for executing the processes described herein.

Memory 405 may include one or more modules for facilitating the functions of fluid delivery system 100 described herein. Modules may be or include stabilization module 407, movement control module 409, fluid delivery control module 411, and/or other modules. Modules may be executed by processor 403 to facilitate the functions described herein.

Stabilization module 407 may be or include computer code which is executed by processor 403 to stabilize and/or support fluid delivery system 100 using one or more of the stabilization schemes described herein. For example, stabilization module 407 may receive inputs from sensors 417 which are processed to determine the position, velocity, acceleration, and/or other characteristics of fluid delivery system 100 at one or more locations. Using this information, stabilization module 407 may determine the forces to be used in supporting fluid delivery system 100 and/or otherwise maintaining the current position of fluid delivery system 100. Actuators 205 may then be controlled to produce the forces using valves 201, nozzles 203, ejection site pumps 211 and/or other components of fluid delivery system (e.g., support devices 300).

Movement control module 409 may be or include computer code which is executed by processor 403 to move fluid delivery system 100 to a desired position or in a desired way. Movement instructions may be received using transceiver 415. Movement instructions may come from a user input device, remote control device, remote computing device (e.g., a computer in wireless communication with control circuit 401), and/or other source. Movement control module 409 may process the instructions and determine the forces required to carry out the movement instructions. Actuators 205 may then be controlled to produce the forces, for moving fluid delivery system 100, using valves 201, nozzles 203, ejection site pumps 211 and/or other components of fluid delivery system (e.g., support devices 300).

Fluid delivery control module 411 may be or include computer code which is executed by processor 403 to move fluid through fluid delivery system 100. Fluid delivery control module 411 may receive commands from transceiver 415 and/or information about a fluid being delivered from sensors 417. Based on the commands and/or information from sensors 417, actuators 205 may be controlled to deliver the fluid. For example, the fluid may be pumped using ejection site pump 211, pumped using pump 109, controlled using one or more valves 201, and/or otherwise manipulated to deliver the fluid.

Control circuit 401 is coupled to transceiver 415 in some embodiments. Transceiver 415 may be any transceiver for communicating using one or more wireless communication protocols and/or techniques. A variety of wireless communications technique or protocols may be used. For example, transceiver 415 may communicate using a wireless network or wireless point to point communication and using one or more protocols such as WiFi, Zigbee, Bluetooth, CDMA, GSM, or other communications protocols (e.g., infrared protocols, optical protocols, ultrasound protocols, etc.). Transceiver 415 may be used to receive commands for controlling fluid delivery system 100 from a remote source. Transceiver 415 may further be used to receive and/or send sensor data between ejection modules 200, to and/or from remote computing hardware, and/or otherwise communicate data from sensors 417 for use by fluid delivery system 100 or related hardware and/or software.

Control circuit 401 is coupled to one or more sensors 417 in some embodiments. Sensors 417 provide information related to movement, acceleration, velocity, position, and/or other characteristics of fluid delivery system 100. Sensors 417 may further provide information related to propulsion fluid 101 and/or other fluids included in fluid delivery system 100. Sensors 417 may include one or more accelerometers 419. Accelerometer 419 may measure the acceleration of fluid delivery system 100 at a specific point. Data from a plurality of accelerometers 419 at various points of fluid delivery system 100 may be used to determine the acceleration, velocity, orientation, and/or position of fluid delivery system 100 as a whole.

Sensors 417 may further include one or more inclinometers 421. Inclinometer 421 may provide data regarding the angle of inclination of fluid delivery system 100 at one point. This data may be used to determine the orientation of fluid delivery system 100 relative to gravity. A plurality of inclinometers 421 may be located at various locations throughout fluid delivery system 100. Data from the plurality of inclinometers may be used to determine the inclination and/or orientation of fluid delivery system 100 as a whole.

Sensors 417 may further include one or more magnetometers. The magnetometer may provide data regarding the orientation of fluid delivery system 100 at a particular point. A plurality of magnetometers may be included throughout fluid delivery system 100 to provide data regarding the orientation of fluid delivery system 100 as a whole.

Sensors 417 may further include one or more gyroscopes 423. Gyroscope 423 may provide data regarding the orientation of fluid delivery system 100 at a particular point. A plurality of gyroscopes 423 may be included throughout fluid delivery system 100 to provide data regarding the orientation of fluid delivery system 100 as a whole.

Sensors 417 may further include one or more cameras. A camera may provide data regarding the orientation of fluid delivery system 100 at a particular point, e.g., by imaging one or more landmarks, imaging a building, etc. A plurality of cameras may be included throughout fluid delivery system 100 to provide data regarding the orientation of fluid delivery system 100 as a whole.

Sensors 417 may include one or more global positioning system (GPS) receivers 425 or other types of electromagnetic receivers. GPS receiver 425 may be used to receive position information from a GPS network corresponding to a particular point of fluid delivery system 100. An electromagnetic receiver may be used to receive position information from a network of external electromagnetic beacons (e.g., visible, IR, or RF beacons located on the ground, on towers, or in buildings) corresponding to a particular point of fluid delivery system 100. A plurality of electromagnetic receivers or GPS receivers 425 may be included throughout fluid delivery system 100 to provide position information at a plurality of points. The plurality of electromagnetic receivers or GPS receivers 425 may be used to determine the position of fluid delivery system 100 as a whole (e.g., using interpolation, modeling, and/or other techniques).

Accelerometers 419, inclinometers 421, magnetometers, cameras, electromagnetic receivers, gyroscopes 423, GPS receivers 425, and/or other sensors 417 may be used alone or together to measure information regarding the state of fluid delivery system 100. This information may be used (e.g., by control circuit 401) to determine characteristics of fluid delivery system 100 such as velocity, position, orientation, acceleration, and/or other characteristics at one or more points or the whole of fluid delivery system 100. Other types of sensors 417 may further be used to determine this and/or other information.

Sensors 417 may further include one or more flow meters 427. Flow meters 427 may be used to determine the flow rate, velocity, and/or other characteristics of propulsion fluid 101 and/or other fluids moving within fluid delivery system 100. Flow meters 427 may be provided at various locations through fluid delivery system 100. For example, flow meters 427 may be provided throughout center channel 331 to determine the velocity of a fluid to be delivered using fluid delivery system 100. Based on this information pump 109 and/or other pumps may be controlled to provide the necessary force to deliver the fluid. Flow meters 427 may further be provided at other locations such as within annulus 333, before nozzle 203, at support devices 300, and/or at other locations. Information from flow meters 427 may be used to adjust components such as valves 201, actuators 205, ejection sites pumps 211, and/or other components to control the forces generated at ejection sites 105.

Sensors 417 may further include one or more pressures transducers 429. Pressure transducers 429 may be used to determine the flow rate, velocity, and/or other characteristics of propulsion fluid 101 and/or other fluids moving within fluid delivery system 100. Pressure transducers 429 may be provided at various locations through fluid delivery system 100. For example, pressure transducers may be provided throughout center channel 331 to determine the pressure of a fluid to be delivered using fluid delivery system 100. Pressure transducers 429 may further be provided at other locations such as within annulus 333, before nozzle 203, at support devices 300, and/or at other locations. Information from pressure transducers 429 may be used to adjust components such as valves 201, actuators 205, ejection sites pumps 211, and/or other components to control the forces generated at ejection sites 105. Information from pressure transducers 429 may further be used to control support segments. In alternative embodiments, other pressure sensors other than pressure transducers 429 are used.

Sensors 417 may further include one or more strain gauges 431. Strain gauges 431 may be located on tube 103 at various locations. Strain gauges 431 may be a part of an ad hoc network which his used to measure the orientation, configuration, shape, and/or position of various locations along tube 103. This and/or other information from strain gauges 431 may be used to control components of fluid delivery system 100 such as support segments.

Sensors 417 may further include additional sensors. For example, sensors 417 may include cameras, microphones, speakers, and/or other environmental sensors for use in directing fluid delivery system 100 and/or communicating with people around fluid delivery system 100. One or more types of sensors 417 may be used in conjunction to determine information for use in controlling fluid delivery system 100. In some embodiments, sensors 417 are wired to one or more control circuits 401. In alternative embodiments, sensors 417 may communicate wirelessly with control circuit 401 and/or be controlled using transceiver 415 coupled to control circuit 401 and/or a local transceiver, transmitter, or receiver at sensor 417.

Control circuit 401 may further be coupled to and/or control power source 413. Power source may be any power source for use in providing power to control circuit 401, sensors 417, actuators 205, and/or other components of fluid delivery system 100. Power source 413 may be a wired connection to a power source (e.g., mains power, a generator, etc.), a battery (e.g., a rechargeable battery), a power scavenger (e.g., a solar panel, a turbine powered by propulsion fluid 101 and/or another fluid, etc.), and/or other source of electrical or mechanical power.

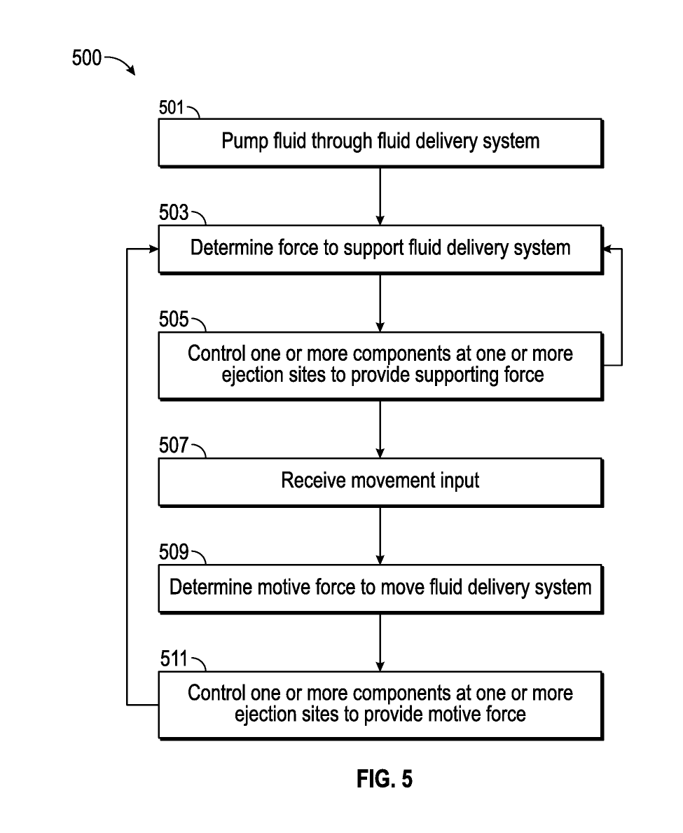

Referring now to FIG. 5, method 500 for delivering fluid using fluid delivery system 100 is illustrated according to one embodiment. A fluid to be delivered is pumped through fluid delivery system 100 (501). The fluid may be propulsion fluid 101 and/or another fluid. The fluid may be pumped using pump 101 from a source. The forces required to support fluid delivery system 100 are determined (503). For example, control circuit 401 may determine the forces to be used to support fluid delivery system 100 using information from one or more sensors 417, information from a remote control or other user input/computer received via transceiver 415, and/or using other information. One or more components at one or more ejection sites 105 are controlled to provide force to support fluid delivery system 100 (505). For example, control circuit 401 may control one or more actuators 205 to produce the forces using nozzles 203, hydraulic turbofans 301, wing systems 303, support members, and/or other support devices 300. Multiple iterations (e.g., continuous iterations) of determining the forces to support fluid delivery system 100 and producing supporting forces may occur. In other words, fluid delivery system 100 may continuously determine the forces needed to support fluid delivery system 100 and generate those forces.

Fluid delivery system 100 receives a movement input (507). The movement input may be an input instructing fluid delivery system 100 to move to a particular location or position. The movement input may be received from control circuit 401 (e.g., as a result of a program or other computer instruction), from a remote control device operated by a user and at transceiver 415, from a remote command and control computer and at transceiver 415, and/or from other sources. In response to the movement command, fluid delivery system 100 determines the motive forces to move fluid delivery system 100 to the indicated position and/or location and/or in the desired manner (509). For example, control circuit 401 may process the movement input or command alone or in conjunction with information form sensors 417 to determine the forces. Fluid delivery system 100 controls one or more components at one or more ejection sites 105 to provide the determined motive force (511). For example, control circuit 401 may control one or more actuators 205 to produce the forces using nozzles 203, hydraulic turbofans 301, wing systems 303, support members, and/or other support devices 300. These steps may also be iterative. For example, fluid delivery system may continuously receive and process movement inputs while also determining the forces used to support fluid delivery system 100.

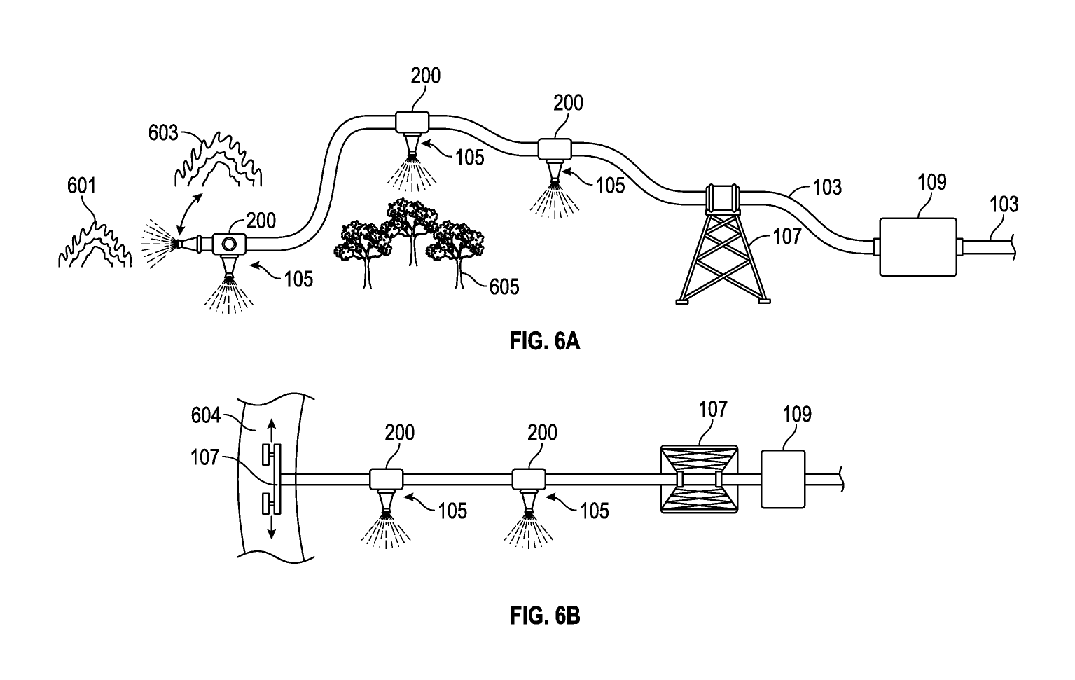

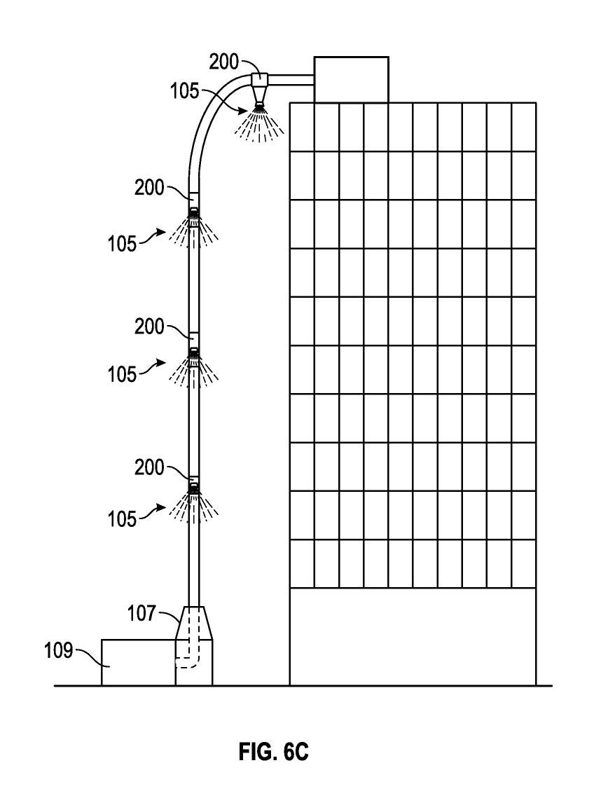

Referring now to FIGS. 6A-6C, fluid delivery system 100 may be used in a variety of fluid delivery applications. Fluid delivery system 100 may be used to deliver water or other fluids to remote areas. These areas may be inaccessible or not easily accessed by traditional fluid delivery systems. Fluid delivery system 100 may advantageously bypass obstacles between the fluid delivery location and the source of the fluid. Fluid delivery system 100 may be positioned above or otherwise around obstacles. Fluid may be delivered any distance. For example, fluid may be delivered by fluid delivery system 100 to a delivery location hundreds or thousands of meters away from the source of the fluid. Fluid delivery system 100 may advantageously deliver fluid with precious timing and to a particular location with precision. Sensors 417 allow for controlled delivery of fluid in applications in which precise timing and/or locations are desirable.

Referring now to FIG. 6A, in some embodiments fluid delivery system 100 may be used in firefighting applications. Advantageously, fluid delivery system 100 may be maneuvered to deliver water and/or other firefighting liquids to a first fire location 601 and may then be maneuvered to a second location 603 and/or more locations. Furthermore, fluid delivery system 100 may draw from any available water source such as natural water sources (e.g., lakes, rivers, etc.) as well as manmade source (e.g., hydrants, water trucks, etc.). Fluid delivery system 100 may be used in firefighting applications without endangering firefighters as firefighters need not approach the fire. Fluid delivery system 100 may be controlled remotely. For example, a firefighter may use cameras located on fluid delivery system 100 and a remote control to direct firefighting by fluid delivery system 100. Torque from fluid delivery system 100 can be used to twist the ejection nozzle of a fire hose so as to direct water to a desired target. Fluid delivery system 100 may maneuver around obstacles 605 such as forested areas which may be inaccessible to traditional firefighting equipment (e.g., fire trucks). This provides an advantage in that water and/or other liquids may be delivered to a wider variety of locations. Additionally, fluid delivery system 100 may use water at ejection sites 105 for support and/or movement of fluid delivery system 100 as well as for firefighting. The ejected fluid may provide both force and be used to extinguish a wire, create a fire line, and/or perform other functions.

Referring now to FIG. 6B, fluid delivery system 100 may be used in agricultural applications in some embodiments. Advantageously, fluid delivery system 100 may be supported at ejection sites 105 without the use of support structures 107 requiring a footprint in or on farmable land. Fluid delivery system 100 may be used to water crops, spray pesticides, deliver fertilizer, and/or otherwise aid in farming applications. As fewer supports are used in comparison to traditional watering mechanisms, more crops may be planted in the same area. Advantageously, the ejected water or other fluid used to support fluid delivery system 100 at ejection sites 105 is also delivered to crops.

In one embodiment, fluid delivery system 100 is supported at first support structure 107 such that fluid delivery system 100 may rotate about the first support structure 107. Fluid delivery system 100 is supported at the other end by a second support structure 107 configured to move around the first support structure (e.g., mounted on wheels). The second support structure may move through path 607. Advantageously, the remainder of fluid delivery system 100 is supported at ejection sites 105 such that additional paths 607 are not used. This further increases the number of crops which may be planted.

Referring now to FIG. 6C, fluid delivery system 100 may be used in other fluid delivery applications such as delivering fluid to locations which are impractical to serve using traditional fluid delivery systems. For example, fluid delivery system 100 may deliver fluid to the top of a building or other structure for which the self-supporting nature of fluid delivery system 100 allows for fluid to be delivered to heights beyond the capabilities of other fluid delivery systems.

In further embodiments, fluid delivery system 100 is used in other applications. For example, fluid delivery system 100 may be used to deliver fluid to delivery locations in near zero gravity environments. Support members may advantageously maintain the configuration of fluid delivery system 100 in near zero gravity environments using pressure. Similarly, fluid delivery system 100 may be used in zero gravity environments.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A fluid delivery system, comprising:
a pump configured to pump a fluid from a source;
a flexible tube extending from the pump and configured to transport the fluid; and
an ejection site located at a position along the length of the tube and configured to eject a propulsion fluid from the tube,
wherein the ejection site is configured to provide support to the fluid delivery system using energy from at least one of the fluid and the propulsion fluid.

2. The fluid delivery system of claim 1, wherein the propulsion fluid comprises at least one of a gas, a liquid, a slurry, and an aerosol.

3. The fluid delivery system of claim 1, wherein the fluid comprises at least one of a gas, a liquid, a slurry, and an aerosol.

4. The fluid delivery system of claim 1, wherein the fluid and the propulsion fluid are the same fluid.

5-11. (canceled)

12. The fluid delivery system of claim 1, further including a support structure located substantially remote from the ejection site, wherein the support structure is configured to support at least a portion of the fluid delivery system.

13-20. (canceled)

21. The fluid delivery system of claim 1, further including:
a valve located at the ejection site and configured to controllably release the propulsion fluid such that a force is generated which at least one of supports, stabilizes, and moves the flexible tube; and
a control circuit configured to control the valve.

22-29. (canceled)

30. The fluid delivery system of claim 21, further including a transceiver coupled to the control circuit, the transceiver configured to provide wirelessly received data to the control circuit, wherein the data includes at least one of (A) information from at least one additional sensor located at a second point along the tube or (B) a command from a remote source, and wherein the control circuit is configured to control the valve based on the data.

31. The fluid delivery system of claim 21, further including a nozzle coupled to the valve and configured to alter the flow of the propulsion fluid from the valve.

32. The fluid delivery system of claim 31, wherein a direction of nozzle is controlled by the control circuit based on at least one of a sensor and a command from a remote source.

33. The fluid delivery system of claim 31, wherein the nozzle includes directional vanes which are controlled by the control circuit based on at least one of a sensor and a command from a remote source.

34-35. (canceled)

36. The fluid delivery system of claim 1, further including:
a valve located at the ejection site and configured to control the flow of a propulsion fluid;
a control circuit configured to control the valve; and
a force enhancer coupled to the valve and configured to use the propulsion fluid to generate a force,
wherein the force enhancer is controlled by the control circuit, and wherein the force generated by the force enhancer at least one of supports at least a portion of the fluid delivery system, stabilizes at least a portion of the fluid delivery system, or moves at least a portion of the fluid delivery system.

37. (canceled)

38. The fluid delivery system of claim 36, wherein the force enhancer is a hydraulic turbofan including:
a hydraulic drive system configured to convert energy from the propulsion fluid into mechanical motion, the hydraulic drive system coupled to the valve and configured to receive the propulsion fluid from the valve;
a shaft coupled to the hydraulic drive system and configured to transmit the mechanical motion; and
at least one blade configured to rotate upon receiving mechanical motion from the shaft and generate aerodynamic lift while rotating.

39. The fluid delivery system of claim 36, wherein the force enhancer is a wing system including:
a nozzle coupled to the valve and configured to eject the propulsion fluid; and
a wing configured to generate lift,
wherein the nozzle is shaped to eject the propulsion fluid over the wing, and wherein the wing is configured to generate lift from the propulsion fluid traveling across the wing.

40. The fluid delivery system of claim 36, wherein the force enhancer is a support member including:
an annulus concentric with the tube and surrounding the tube, the annulus configured to be pressurized by the propulsion fluid entering the annulus from the valve,
wherein the annulus is configured to become a semi-rigid structure when pressurized by the propulsion fluid, and where the semi-rigid structure at least partially supports the weight of the fluid delivery system.

41-43. (canceled)

44. The fluid delivery system of claim 36, further including a sensor configured to measure at least one of the orientation, position, acceleration, or velocity at a point along the tube, and wherein the control circuit is configured to control the valve based on information from the at least one sensor.

45-48. (canceled)

49. The fluid delivery system of claim 36, further including a transceiver coupled to the control circuit, the transceiver configured to provide wirelessly received data to the control circuit, wherein the data includes at least one of (A) information from at least one additional sensor located at a second point along the tube or (B) a command from a remote source, and wherein the control circuit is configured to control the valve based on the data.

50. (canceled)

51. A fluid delivery system, comprising:
a pump configured to pump a fluid from a source;
a flexible tube extending from the pump and configured to transport the fluid; and
an ejection module located at an ejection site located at a position along the length of the tube, the ejection module including:
a valve configured to control the flow of a propulsion fluid;
a control circuit configured to control the valve; and
a hydraulic turbofan coupled to the valve and configured to use the propulsion fluid to generate a force,
wherein the hydraulic turbofan is controlled by the control circuit, and wherein the force generated by the hydraulic turbofan at least one of supports at least a portion of the fluid delivery system, stabilizes at least a portion of fluid delivery system, or moves at least a portion of the fluid delivery system.

52-57. (canceled)

58. The fluid delivery system of claim 51, further including an ejection site pump coupled to the valve and configured to increase the flow rate of the propulsion fluid.

59. The fluid delivery system of claim 51, wherein the hydraulic turbofan includes:
a hydraulic drive system configured to convert energy from the propulsion fluid into mechanical motion, the hydraulic drive system coupled to the valve and configured to receive the propulsion fluid from the valve;
a shaft coupled to the hydraulic drive system and configured to transmit the mechanical motion; and
at least one blade configured to rotate upon receiving mechanical motion from the shaft, and further configured to generate aerodynamic lift while rotating.

60. The fluid delivery system of claim 59, wherein the hydraulic turbofan further includes an actuator configured to change the orientation of the hydraulic turbofan, and wherein a control circuit is configured to control the actuator.

61. The fluid delivery system of claim 60, wherein the control circuit is configured to direct a thrust of the hydraulic turbofan by controlling the actuator.

62. The fluid delivery system of claim 59, wherein an outlet of the hydraulic drive system is coupled to the tube, and wherein the propulsion fluid is returned to the tube after passing through the hydraulic drive system.

63. The fluid delivery system of claim 59, wherein an outlet of the hydraulic drive system is coupled to the tube, and wherein the propulsion fluid is ejected from the tube after passing through the hydraulic drive system.

64. (canceled)

65. The fluid delivery system of claim 51, wherein the propulsion fluid is a second fluid other than the fluid.

66. The fluid delivery system of claim 65, wherein the propulsion fluid is drawn from a lumen of the tube separate from a second lumen through which the fluid is pumped.

67-72. (canceled)

73. The fluid delivery system of claim 51, further including a transceiver coupled to the control circuit, the transceiver configured to provide wirelessly received data to the control circuit, wherein the data includes at least one of information from at least one additional sensor located at a second point along the tube or a command from a remote source, and wherein the control circuit is configured to control the valve based on the data.

74. The fluid delivery system of claim 73, wherein the control circuit is configured to control the hydraulic turbofan based on the data.

75-121. (canceled)

122. A fluid delivery system, comprising:
a pump configured to pump the fluid from a source;
a flexible tube extending from the pump and configured to transport the fluid; and
an ejection module located at an ejection site located at a position along the length of the tube, the ejection module including:
a valve configured to control the flow of a propulsion fluid;
a control circuit configured to control the valve; and
a support member coupled to the valve and configured to use the propulsion fluid to support the flexible tube.

123-128. (canceled)

129. The fluid delivery system of claim 122, further including an ejection site pump coupled to the valve and configured to increase the flow rate of the propulsion fluid.

130. The fluid delivery system of claim 122, wherein the support member includes:
an annulus concentric with the tube and surrounding the tube, the annulus configured to be pressurized by the propulsion fluid entering the annulus from the valve,
wherein the annulus becomes semi-rigid when pressurized by the propulsion fluid, and where the semi-rigid structure at least partially supports the weight of the fluid delivery system.

131-132. (canceled)

133. The fluid delivery system of claim 130, wherein the support member further includes a second valve, wherein the second valve is configured to drain the annulus into the tube.

134. The fluid delivery system of claim 130, wherein the annulus is segmented into a plurality of segments, and wherein the plurality of segments run the length of the support member.

135. The fluid delivery system of claim 134, wherein each segment of the plurality of segments includes a separate valve configured to provide the propulsion fluid to each segment.

136. The fluid delivery system of claim 134, wherein each segment of the plurality of segments includes a separate ejection site pump configured to pressurize the segment.

137. The fluid delivery system of claim 134, wherein the control circuit is configured to control pressurization of each segment individually, and wherein the shape of the fluid delivery system is controlled by the control circuit.

138-225. (canceled)
